(19) United States
(12) Patent Application Publication
(10) Pub. No.: US 2024/0054541 A1
(43) Pub. Date: Feb. 15, 2024

(54) Remote Customer Service System and Remote Customer Service Method

(71) Applicant: Hitachi, Ltd., Tokyo (JP)

(72) Inventors: Kenji FUJIHIRA, Tokyo (JP); Hideki OKITA, Tokyo (JP)

(21) Appl. No.: 18/196,906

(22) Filed: May 12, 2023

(30) Foreign Application Priority Data
Aug. 12, 2022 (JP) 2022-128975

(51) Int. Cl. G06Q 30/0601; G06Q 10/0631

(52) U.S. Cl. CPC G06Q 30/0613; G06Q 10/063114; G06Q 10/063112

(57) ABSTRACT

Remote customer service that reduces work to be done by customers and inhibits loss of sales opportunities is realized. A remote customer service system retains condition information representing a condition related to a sensing value of a sensor that senses an action of a customer regarding an item arranged at a facility, and clerk information representing a store where a clerk who is capable of providing customer service regarding the item is stationed. The remote customer service system acquires a sensing value of the sensor, generates a customer service request in a case where it is determined that the acquired sensing value satisfies the condition, transmits the customer service request to a computer arranged at a store represented by the clerk information, and executes remote communication between a computer having received the customer service request and a computer arranged at the facility.

### CLAIM OF PRIORITY

The present application claims priority from Japanese patent application JP 2022-128975 filed on Aug. 12, 2022, the content of which is hereby incorporated by reference into this application.

### BACKGROUND OF THE INVENTION

### 1. Field of the Invention

The present invention relates to a remote customer service system and a remote customer service method.

### 2. Description of the Related Art

As a background art of this technical field, there is a technology disclosed in Japanese Patent Laid-open No. 2019-79269 (hereinafter, referred to as Patent Document 1). The publication of the application describes that “A remote customer service program causes a computer to execute a process of accepting, from a terminal of a customer, input or selection of information that specifies an item and information that specifies a region where the item is planned to be used. The remote customer service program causes the computer to execute a process of specifying a salesperson who handles the item and is associated with the region. In addition, the remote customer service program causes the computer to execute a process of allowing communication between a terminal of a selected salesperson and the terminal of the customer.” (see Abstract).

### SUMMARY OF THE INVENTION

The technology described in Patent Document 1 requires input or selection, on the terminal, of information regarding an item that the customer is interested in, and accordingly requires work to be done by the customer. In addition, there is a fear regarding the technology described in Patent Document 1 that, in a case where the customer who holds, in her/his hand, an item that she/he is interested in dislikes the work described above and does not input or select information to or on a terminal, customer service by a clerk at a store which is at a remote location is not started, and accordingly loss of sales opportunities occurs.

In view of this, an aspect of the present invention realizes remote customer service that reduces work to be done by customers and inhibits loss of sales opportunities.

In order to solve the problems described above, an aspect of the present invention adopts the following configuration. A remote customer service system retains condition information representing a condition related to a sensing value of a sensor that senses an action of a customer regarding an item arranged at a facility, and clerk information representing a store where a clerk who is capable of providing customer service regarding the item is stationed. The remote customer service system includes a sensor processing section that acquires a sensing value of the sensor, and generates a customer service request in a case where it is determined that the acquired sensing value satisfies the condition, a customer service managing section that transmits the customer service request to a computer arranged at a store represented by the clerk information, and a remote communication section that executes remote communication between a computer having received the customer service request and a computer arranged at the facility.

An aspect of the present invention can realize remote customer service that reduces work to be done by customers and inhibits loss of sales opportunities.

Problems, configuration, and advantages other than those described above are made clear by the following explanation of an embodiment.

### BRIEF DESCRIPTION OF THE DRAWINGS

FIG. 1 is a block diagram depicting a configuration example of a remote customer service system in a first embodiment;

FIG. 2 is a block diagram depicting a configuration example of a customer service management server in the first embodiment;

FIG. 3 is a block diagram depicting a configuration example of a terminal in the first embodiment;

FIG. 4 is a block diagram depicting a configuration example of a robot in the first embodiment;

FIG. 5 is a figure depicting a data configuration example of a clerk management table in the first embodiment;

FIG. 6 is a figure depicting a data configuration example of a customer service request condition management table in the first embodiment;

FIG. 7 is a figure depicting a data configuration example of a sample item management table in the first embodiment;

FIG. 8 is a figure depicting a data configuration example of a clerk image table in the first embodiment;

FIG. 9 is a sequence diagram depicting an example of an overall process of the remote customer service system in the first embodiment;

FIG. 10 is a sequence diagram depicting an example of the overall process of the remote customer service system in the first embodiment;

FIG. 11 is a flowchart depicting an example of a specific process performed by the terminal in the first embodiment;

FIG. 12 is a flowchart depicting an example of a specific process performed by the customer service management server in the first embodiment;

FIG. 13 is a flowchart depicting an example of a specific process performed by the robot in the first embodiment;

FIG. 14 is a figure depicting a screen configuration example of a clerk-awaited-state screen in the first embodiment; and

FIG. 15 is a figure depicting a screen configuration example of a customer service wish screen in the first embodiment.

### DESCRIPTION OF THE PREFERRED EMBODIMENT

An embodiment of the present invention is explained in detail below on the basis of the figures. In the present embodiment, identical constituent elements are in principle given identical reference characters, and repetitive explanations are omitted. It should be noted that the present embodiment is merely an example for realizing the present invention and does not limit the technical scope of the present invention.

### First Embodiment

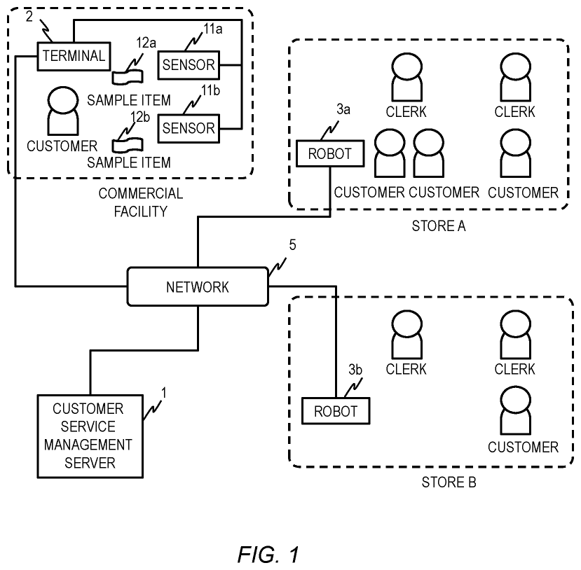

FIG. 1 is a block diagram depicting a configuration example of a remote customer service system. In the present embodiment, a store-operating company has one or more stores (it is supposed in the present embodiment that it has two stores which are Store A and Store B) where clerks are stationed. Further, in the present embodiment, the store-operating company has one or more facilities that are different from the one or more stores (it is supposed in the present embodiment that there is one commercial facility). Clerks are not stationed at the facility, but the company arranges sample items in the facility, and remote customer service can be provided in the facility by clerks stationed at the one or more stores. That is, clerks at Store A and Store B give explanations regarding items face-to-face to customers who visit the stores and, in addition, provide remote customer service also to customers who visit the commercial facility.

For example, the remote customer service system includes a customer service management server 1, a terminal 2, a robot 3a, a robot 3b, a sensor 11a, a sensor 11b, a sample item 12a, and a sample item 12b. For example, the customer service management server 1, the terminal 2, the robot 3a, and the robot 3b are connected to each other by a network 5 such as the Internet.

The customer service management server 1 executes an intermediation process for executing remote customer service between a customer at a commercial facility where the terminal 2 is arranged and a clerk at a store where the robot 3a or the robot 3b is arranged.

The terminal 2, the sensor 11a, the sensor 11b, the sample item 12a, and the sample item 12b are arranged in the commercial facility. Note that, whereas it is sufficient if one or more sample items and sensors corresponding to the one or more sample items are arranged at the commercial facility, two sample items and two sensors are arranged in an example explained in the present embodiment.

The sensor 11a is a sensor for sensing information for estimating whether a customer at the commercial facility has exhibited a behavior expressing her/his wish to be given an explanation regarding the sample item 12a. Similarly, the sensor 11b is a sensor that senses information for estimating whether a customer at the commercial facility has exhibited a behavior expressing her/his wish to be given an explanation regarding the sample item 12b. A robot is arranged at each store. It is supposed in the present embodiment that the robot 3a is arranged at Store A and the robot 3b is arranged at Store B.

The terminal 2 transmits a customer service request to the robot 3a and/or the robot 3b via the customer service management server 1 in a case where it is estimated that a customer at the commercial facility has exhibited a behavior expressing her/his wish to be given an explanation regarding the sample item 12a or the sample item 12b, and remote customer service between the customer at the commercial facility and a clerk at the store where the robot 3a or the robot 3b is arranged is thereby realized by using the terminal 2 and the robot 3a or the robot 3b.

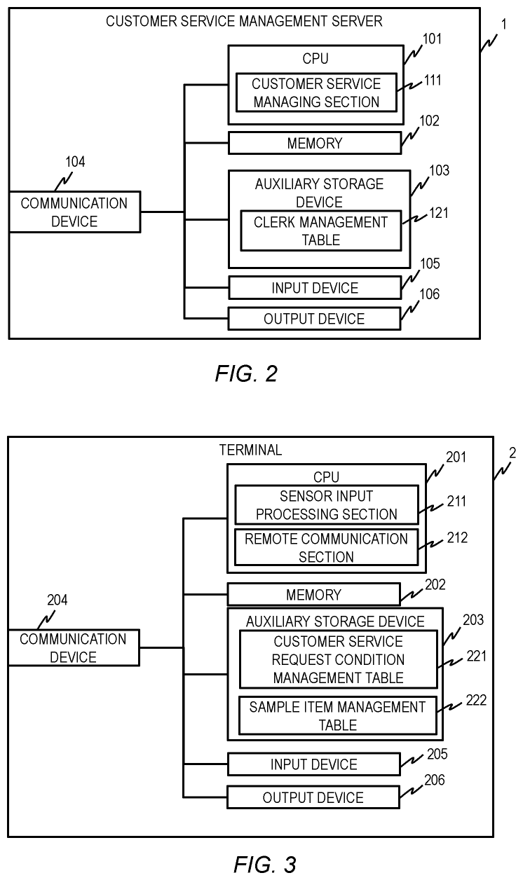

FIG. 2 is a block diagram depicting a configuration example of the customer service management server 1. For example, the customer service management server 1 includes a computer having a central processing unit (CPU) 101, a memory 102, an auxiliary storage device 103, a communication device 104, an input device 105, and an output device 106.

The CPU 101 includes a processor, and executes a program stored on the memory 102. The memory 102 includes a read only memory (ROM) which is a non-volatile storage element and a random access memory (RAM) which is a volatile storage element. The ROM stores thereon an invariable program (e.g., basic input/output system (BIOS)) and the like. The RAM is a high-speed and volatile storage element, such as a dynamic random access memory (DRAM), and temporarily stores thereon programs to be executed by the CPU 101 and data to be used when the programs are executed.

For example, the auxiliary storage device 103 is a large-capacity and non-volatile storage device such as a magnetic storage device (hard disk drive (HDD)) or a flash memory (solid state drive (SSD)), and stores thereon programs to be executed by the CPU 101 and data to be used when the programs are executed. That is, the programs are read out from the auxiliary storage device 103, loaded onto the memory 102, and executed by the CPU 101.

The input device 105 is a device, such as a keyboard or a mouse, that accepts input from an operator. The output device 106 is a device, such as a display device or a printer, that outputs results of execution of programs in such formats that an operator can visually recognize the results.

The communication device 104 is a network interface device that controls communication with other devices in accordance with a predetermined protocol. In addition, for example, the communication device 104 may include a serial interface such as a universal serial bus (USB).

Some or all of programs executed by the CPU 101 may be provided, via a network, to the customer service management server 1 from a removable medium (compact disc (CD)-ROM, flash memory, etc.) which is a non-transitory storage medium or from an external computer including a non-transitory storage device, and stored on the non-volatile auxiliary storage device 103, which is a non-transitory storage medium. Because of this, the customer service management server 1 preferably has an interface used to read in data from a removable medium. The same applies also to the terminal 2, the robot 3a, and the robot 3b.

The customer service management server 1 is a computer system configured physically on one computer or configured on a plurality of logically or physically configured computers, and may operate on separate threads on a single computer or may operate on a virtual computer built on a plurality of physical computer resources. The same applies also to the terminal 2, the robot 3a, and the robot 3b.

For example, the CPU 101 includes a customer service managing section 111. The customer service managing section 111 controls processes for executing remote customer service between the terminal 2 and the robot 3a and robot 3b.

For example, the CPU 101 functions as the customer service managing section 111 by operating according to a customer service program loaded onto the memory 102. This relation between a program and functional sections applies also to functional sections, which will be described later, included in a CPU 201, which will be described later, of the terminal 2 and in a CPU 301, which will be described later, of each of the robot 3a and the robot 3b.

Note that, for example, some or all of functionalities by the functional sections included in the CPU 101, the CPU 201 of the terminal 2, and the CPUs 301 of the robot 3a and the robot 3b may be realized by hardware such as an application specific integrated circuit (ASIC) or a field-programmable gate array (FPGA).

For example, the auxiliary storage device 103 retains a clerk management table 121. The clerk management table 121 retains information representing items regarding which clerks at each store are capable of giving explanations and skills related to explanations regarding the items (customer service).

Note that partial or the whole information stored on each of the auxiliary storage device 103, an auxiliary storage device 203, which will be described later, of the terminal 2 and an auxiliary storage device 303, which will be described later, of each of the robot 3a and the robot 3b may be stored on the memory 102, a memory 202, and a memory 302, or may be stored on external databases.

Note that, in the present embodiment, information to be used by the remote customer service system does not depend on data structures, and may be expressed in any data structures. Whereas information is expressed in table formats in the present embodiment, for example, data structures appropriately selected from lists, databases, or queues can store the information.

FIG. 3 is a block diagram depicting a configuration example of the terminal 2. For example, the terminal 2 includes a computer having the CPU 201, the memory 202, the auxiliary storage device 203, a communication device 204, an input device 205, and an output device 206.

Explanations regarding the CPU 201, the memory 202, the auxiliary storage device 203, the communication device 204, the input device 205, and the output device 206 as hardware are similar to the explanations regarding the CPU 101, the memory 102, the auxiliary storage device 103, the communication device 104, the input device 105, and the output device 106 as hardware, and accordingly are omitted. Note that, in order for a customer of the commercial facility to be provided with remote customer service, the input device 205 may further include a camera, a microphone, or the like and the output device 206 may further include a speaker or the like.

For example, the CPU 201 includes a sensor input processing section 211 and a remote communication section 212. The sensor input processing section 211 estimates whether a customer at the commercial facility has exhibited a behavior expressing her/his wish to be given an explanation regarding the sample item 12a and the sample item 12b (whether she/he is requesting customer service), on the basis of sensing values of the sensor 11a and the sensor 11b. The remote communication section 212 executes a process for realizing remote communication with clerks who use the robot 3a and the robot 3b.

For example, the auxiliary storage device 203 retains a customer service request condition management table 221 and a sample item management table 222. The customer service request condition management table 221 retains information representing customer service request conditions (e.g., conditions for determining that a customer at the commercial facility has exhibited a behavior expressing her/his wish to be given an explanation regarding the sample item 12a and the sample item 12b). The sample item management table 222 retains information for managing sample items arranged at the commercial facility and sensors corresponding to the sample items.

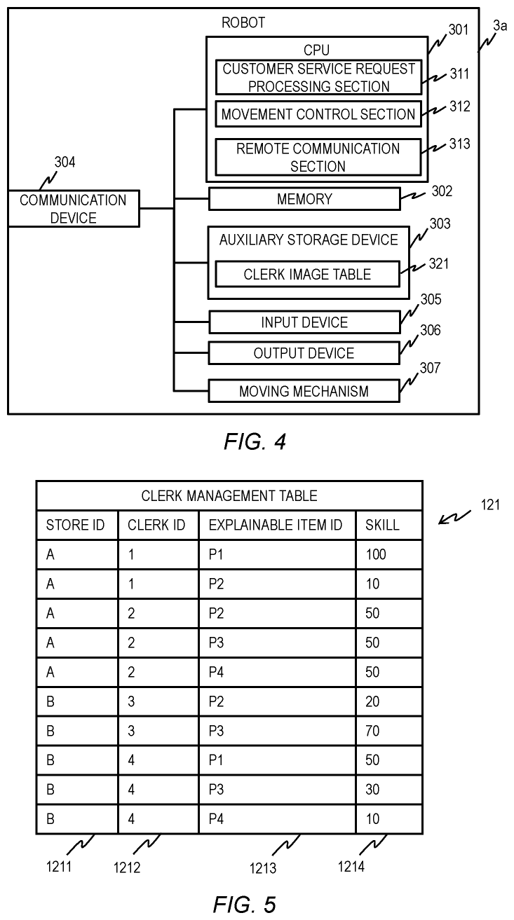

FIG. 4 is a block diagram depicting a configuration example of the robot 3a. Since a configuration example of the robot 3b is similar to the configuration example of the robot 3a, an explanation thereof is omitted. For example, the robot 3a includes a mechanism as a computer having the CPU 301, the memory 302, the auxiliary storage device 303, a communication device 304, an input device 305, and an output device 306, and also includes a moving mechanism 307. Explanations regarding the CPU 301, the memory 302, the auxiliary storage device 303, the communication device 304, the input device 305, and the output device 306 as hardware are similar to the explanations regarding the CPU 101, the memory 102, the auxiliary storage device 103, the communication device 104, the input device 105, and the output device 106 as hardware, and accordingly are omitted. Note that, in order for a clerk at a store to provide remote customer service, the input device 305 may further include a camera, a microphone, or the like, and the output device 306 may further include a speaker or the like. In addition, the camera is used for recognition of clerks described later.

For example, the CPU 301 includes a customer service request processing section 311, a movement control section 312, and a remote communication section 313. The customer service request processing section 311 executes processes regarding a customer service request and a clerk-awaited-state notification described later. The movement control section 312 executes a process of controlling the moving mechanism 307 to move the robot 3a. The remote communication section 313 executes a process for realizing remote communication with a customer of the commercial facility who uses the terminal 2.

For example, the auxiliary storage device 303 retains a clerk image table 321. The clerk image table 321 retains information representing images of clerks who are stationed at the store where the robot is arranged. For example, the moving mechanism 307 includes a mechanism, such as wheels, crawlers, or a motor, for moving the robot 3a.

FIG. 5 is a figure depicting a data configuration example of the clerk management table 121. For example, the clerk management table 121 includes store identification (ID) fields 1211, clerk ID fields 1212, explainable item ID fields 1213, and skill fields 1214. A store ID field 1211 retains a store ID that identifies a store. A clerk ID field 1212 retains a clerk ID that identifies a clerk. An explainable item ID field 1213 retains an item ID of an item regarding which the clerk at the store is capable of giving an explanation. A skill field 1214 retains an index value representing a skill (e.g., an explanation skill) that the clerk at the store has regarding the explainable item.

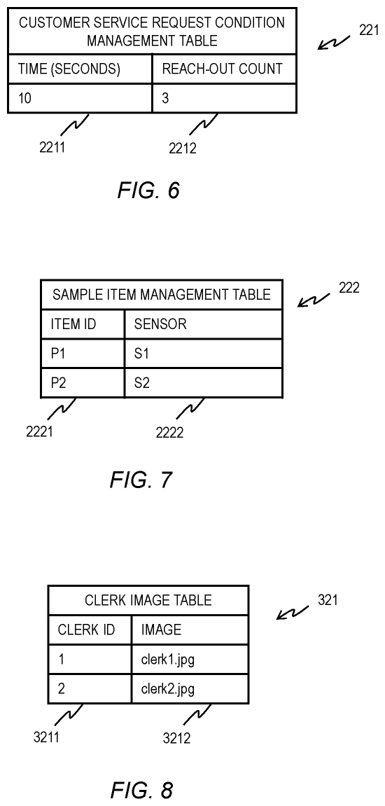

FIG. 6 is a figure depicting a data configuration example of the customer service request condition management table 221. For example, the customer service request condition management table 221 includes a time field 2211 and a reach-out count field 2212. The time field 2211 represents a time-related condition that has to be satisfied for a customer service request to be transmitted. The reach-out count field 2212 represents a condition related to the number of times that a customer reaches out for a sample item, the condition having to be satisfied for a customer service request to be transmitted. Note that, for example, if the sensor 11a and the sensor 11b are cameras, the sensor input processing section 211 can use images captured by the cameras to determine time during which customers hold the sample item 12a and the sample item 12b and the numbers of times that the customers reach out for the sample item 12a and the sample item 12b. In addition, for example, if the sensor 11a and the sensor 11b are three-dimensional (3D) light detection and ranging (LiDAR) sensors, the sensor input processing section 211 can use results of sensing, by the 3D LiDAR sensors, of objects that have passed before shelves on which the sample item 12a and the sample item 12b are placed, to determine time during which customers hold the sample item 12a and the sample item 12b and the numbers of times that the customers reach out for the sample item 12a and the sample item 12b.

The customer service request condition management table 221 in FIG. 6 represents that the condition that has to be satisfied for a customer service request to be transmitted is that a customer reaches out for a sample item three times in ten seconds. In addition, the customer service request condition management table 221 may further include item ID fields regarding sample items. That is, different conditions may be defined for different item IDs in the customer service request condition management table 221.

In addition, whereas the customer service request condition management table 221 represents the time-related condition and the reach-out-count-related condition in the example depicted in FIG. 6, only either one of the time-related condition and the reach-out-count-related condition may be used (e.g., that a customer holds a sample item for at least three seconds, that a customer reaches out for a sample item, etc.), or there may be a condition related to an index other than the time-related condition and the reach-out-count-related condition (e.g., that a customer at the commercial facility inputs information (e.g., an item ID) that specifies a sample item regarding which she/he wishes to be given an explanation, to the input device 205 of the terminal 2, etc.).

FIG. 7 is a figure depicting a data configuration example of the sample item management table 222. For example, the sample item management table 222 includes item ID fields 2221 and sensor ID fields 2222. An item ID field 2221 retains an item ID of a sample item arranged at the commercial facility. A sensor ID field 2222 retains a sensor ID of a sensor corresponding to the sample item (i.e., a sensor that senses an action of a customer that serves as a trigger of a customer service request regarding the sample item).

FIG. 8 is a figure depicting a data configuration example of the clerk image table 321. For example, the clerk image table 321 includes clerk ID fields 3211 and image fields 3212. A clerk ID field 3211 retains a clerk ID of a clerk stationed at a store where a robot retaining the clerk image table 321 is installed. An image field 3212 retains image data of the face or the like of the clerk.

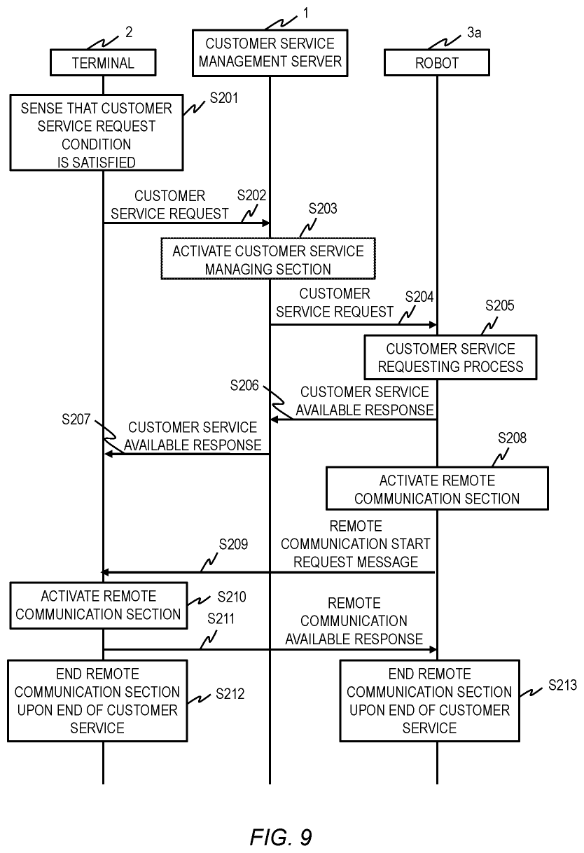

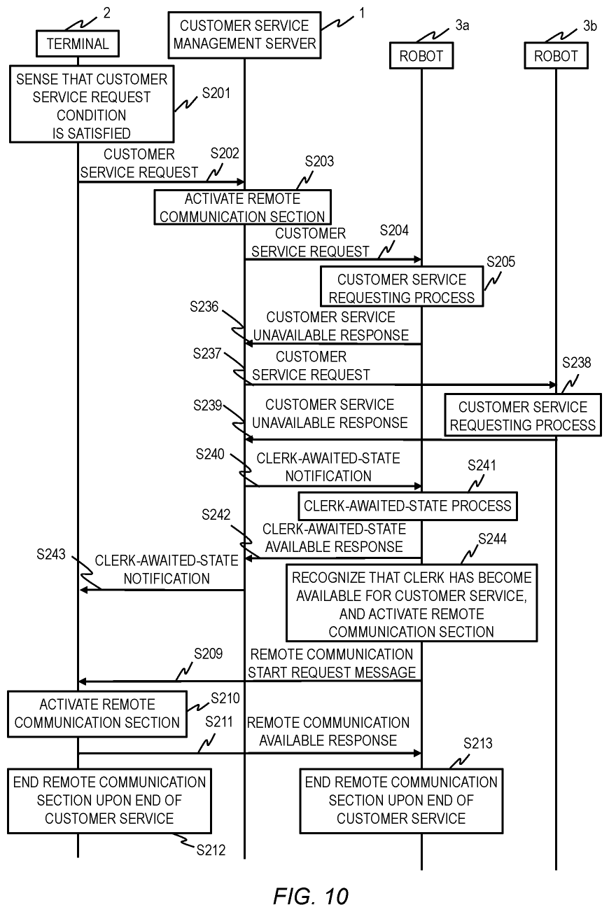

FIG. 9 and FIG. 10 are sequence diagrams depicting examples of an overall process of the remote customer service system. An example in which a clerk-awaited state does not occur is explained with reference to FIG. 9, and an example in which a clerk-awaited state occurs is explained with reference to FIG. 10. Note that an overview of the overall process is explained with reference to FIG. 9 and FIG. 10 (some processes are omitted in the explanation), and specific processes by each device are explained by using FIG. 10 to FIG. 12. First, FIG. 9 is explained.

The sensor input processing section 211 of the terminal 2 senses that a customer service request condition is satisfied at the commercial facility where the terminal 2 is installed (S201). The sensor input processing section 211 transmits a customer service request to the customer service management server 1 (S202). The customer service managing section 111 of the customer service management server 1 is activated (S203), the customer service managing section 111 selects a robot to which a customer service request is to be transmitted (i.e., a robot arranged at a store where there is a clerk who has the ability to provide remote customer service) (it is supposed in the example depicted in FIG. 9 that at least the robot 3a is selected), and transmits the customer service request to the selected robot (S204).

The customer service request processing section 311 of the robot 3a having received the customer service request executes a customer service requesting process (S205). It is supposed that, in the example depicted in FIG. 9, at Store A where the robot 3a is arranged, there is a clerk who is capable of providing remote customer service to a customer who is at the commercial facility. The customer service request processing section 311 of the robot 3a transmits a customer service available response to the customer service management server 1 (S206).

The customer service managing section 111 of the customer service management server 1 transmits the received customer service available response to the terminal 2 having transmitted the customer service request (S207). The robot 3a having transmitted the customer service available response activates the remote communication section 313 (S208), and the remote communication section 313 transmits a remote communication start request message to the terminal 2 having transmitted the customer service request (S209).

The terminal 2 having received the remote communication start request message activates the remote communication section 212 (S210), and transmits a remote communication available response to the robot 3a having (S211). Thereafter, remote customer service using the terminal 2 and the robot 3a is performed. Upon the end of the remote customer service, the remote communication section 212 of the terminal 2 is ended (S212), and the remote communication section 313 of the robot 3a is ended (S213).

Next, FIG. 10 is explained. First, the processes in Step S201 to Step S205 are performed. Note that it is supposed in the example depicted in FIG. 10 that the customer service managing section 111 has selected the robot 3a and the robot 3b as robots to which customer service requests are to be transmitted (i.e., as robots arranged at stores where there are clerks having the ability to provide remote customer service). Further, it is supposed that the customer service managing section 111 has transmitted the customer service request to the robot 3a first since it is determined that the robot 3a has a higher priority regarding transmission of the customer service requests over the robot 3b.

Since the customer service request processing section 311 of the robot 3a determines that a clerk having the ability to provide remote customer service is not available for customer service at Store A where the robot 3a is arranged (e.g., the clerk is occupied with customer service for a customer at Store A) in the example depicted in FIG. 10, the customer service request processing section 311 transmits a customer service unavailable response to the customer service management server 1 (S236). The customer service managing section 111 of the customer service management server 1 having received the customer service unavailable response from the robot 3a transmits a customer service request to the robot 3b having the highest priority next to the robot 3a (S237).

The customer service request processing section 311 of the robot 3b having received the customer service request executes a customer service requesting process (S238). The customer service requesting process in Step S238 is similar to the customer service requesting process in Step S205. In the example depicted in FIG. 10, since the customer service request processing section 311 of the robot 3b determines that a clerk having the ability to provide remote customer service is not available for customer service at Store B where the robot 3b is arranged (e.g., the clerk is occupied with customer service for a customer at Store B), the customer service request processing section 311 transmits a customer service unavailable response to the customer service management server 1 (S239).

Since the customer service managing section 111 has received the customer service unavailable responses from all the selected robots, the customer service managing section 111 transmits a clerk-awaited-state notification to the robot 3a having the highest priority (S240). The customer service request processing section 311 and the movement control section 312 of the robot 3a having received the clerk-awaited-state notification executes a process in a clerk-awaited state (S241). The customer service request processing section 311 of the robot 3a having executed the process in the clerk-awaited state transmits a clerk-awaited-state available response to the customer service management server 1 (S242). The customer service managing section 111 of the customer service management server 1 having received the clerk-awaited-state available response transmits a clerk-awaited-state notification to the terminal 2 having transmitted the customer service request (S243).

When the customer service request processing section 311 of the robot 3a having transmitted the clerk-awaited-state available response recognizes that the clerk having the ability to provide remote customer service at Store A has become available for customer service, the robot 3a activates the remote communication section 313 (S244). Thereafter, the processes in Step S209 to Step S213 are executed.

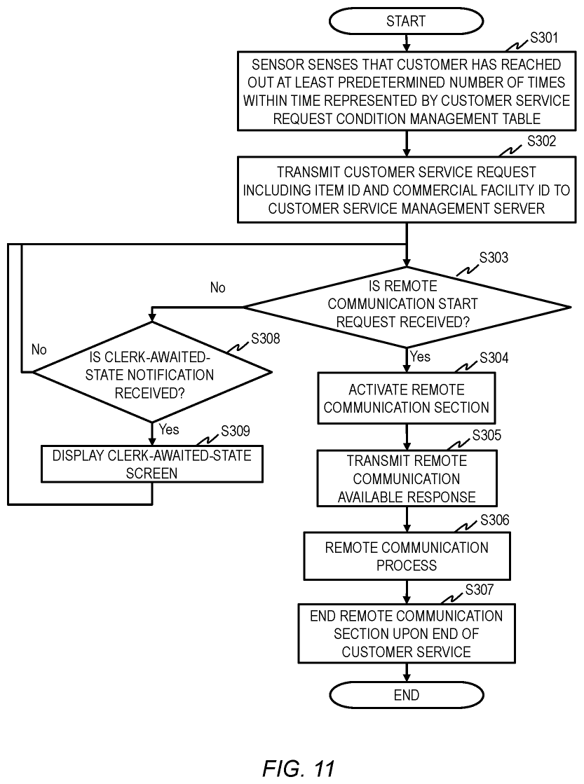

FIG. 11 is a flowchart depicting an example of a specific process performed by the terminal 2. The sensor input processing section 211 receives sensor values from the sensor 11a and the sensor 11b, and determines that sensor values of at least one of the sensor 11a and the sensor 11b satisfy the conditions represented by the customer service request condition management table 221 (S301). Specifically, the sensor input processing section 211 determines, on the basis of the received sensor values, that a customer has reached out, within time represented by the customer service request condition management table 221, for a sample item the number of times represented by the customer service request condition management table 221. The process in Step S301 corresponds to the process in Step S201.

The sensor input processing section 211 specifies, by referring to the sample item management table 222, the item ID of the sample item corresponding to the sensor whose sensed sensor values satisfy the conditions represented by the customer service request condition management table 221, and transmits, to the customer service management server 1, a customer service request including the specified item ID and a commercial facility ID (S302). Note that it is supposed that the commercial facility ID is registered in the terminal 2 in advance. The process in Step S302 corresponds to the process in Step S202.

The sensor input processing section 211 determines whether a remote communication start request message has been received from any of the robots (S303). In a case where the sensor input processing section 211 determines that a remote communication start request message has been received from any of the robots (S303: Yes), the remote communication section 212 is activated (S304). The process in Step S304 corresponds to the process in Step S210.

The remote communication section 212 transmits a remote communication available response to the robot having (S305). The process in Step S305 corresponds to the process in Step S211. The remote communication section 212 executes a remote communication process (S306). Specifically, for example, the remote communication section 212 controls a camera and a microphone included in the input device 205, a speaker included in the output device 206, and the like to realize a video telephone functionality or the like between a clerk who uses the robot and a customer who uses the terminal 2, to thereby realize remote communication.

Upon the end of customer service, the remote communication section 212 is ended (S307), and the process performed by the terminal 2 ends. For example, the end of customer service is triggered by the customer at the commercial facility inputting a customer service end instruction by using the input device 205 of the terminal 2, the clerk at the store where the robot is arranged inputting a customer service end instruction by using the input device 305 of the robot, or the like. The process in Step S307 corresponds to the process in Step S212.

In a case where the sensor input processing section 211 determines that a remote communication start request message has been received from neither of the robots (S303: No), the sensor input processing section 211 determines whether a clerk-awaited-state notification has been received from either robot (S308). In a case where the sensor input processing section 211 determines that a clerk-awaited-state notification has been received from neither of the robots (S308: No), the procedure return to Step S303.

In a case where the sensor input processing section 211 determines that a clerk-awaited-state notification has been received from either robot (S308: Yes), a clerk-awaited-state screen is displayed on a display included in the output device 206 (S309), and the procedure returns to Step S303. For example, the clerk-awaited-state screen displays a message indicating that a clerk at remote store can give an explanation (customer service) regarding the sample item that the customer of the commercial facility holds in her/his hand, a message indicating that the customer is being asked to wait for customer service since the clerk is occupied with customer service, or the like.

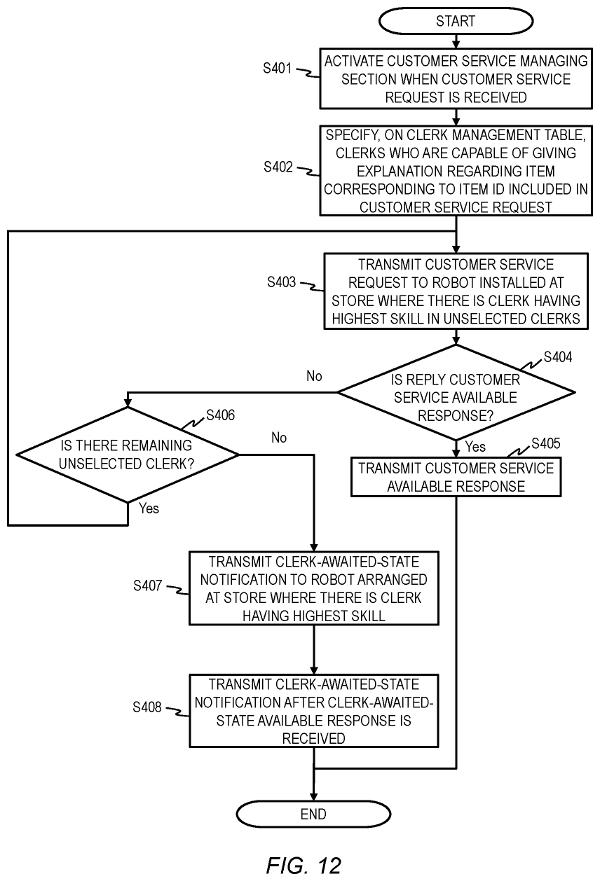

FIG. 12 is a flowchart depicting an example of a specific process performed by the customer service management server 1. Upon reception of a customer service request from the terminal 2, the customer service management server 1 activates the customer service managing section 111 (S401). The customer service managing section 111 acquires, from the clerk management table 121, records including, as an explainable item ID, an item ID included in the customer service request, and specifies store IDs, clerk IDs, and skills of clerks represented by the records (S402).

The customer service managing section 111 specifies unselected clerks from the clerks specified in Step S402, specifies the store ID and the clerk ID of a clerk having the highest skill in the unselected clerks, and transmits a customer service request including the clerk ID to a robot installed at the store represented by the store ID (S403). The process in Step S403 corresponds to the process in Step S204 and the process in Step S237.

The customer service managing section 111 determines whether a customer service available response has been received from the robot as a reply to the customer service request transmitted in the latest Step S403 (S404). In a case where the customer service managing section 111 determines that a customer service available response has been received as the reply (S404: Yes), the customer service managing section 111 transmits a customer service available response to the terminal 2 having transmitted the customer service request received in Step S401 (S405), and ends the process performed by the customer service management server 1. Note that the process in Step S405 corresponds to the process in Step S207.

In a case where the customer service managing section 111 determines that a message received as the reply is not a customer service available response (i.e., the received message is a customer service unavailable response) (S404: No), the customer service managing section 111 determines whether an unselected clerk is included in the clerks specified in Step S402 (S406). In a case where the customer service managing section 111 determines that there is an unselected clerk (S406: Yes), the procedure returns to Step S403.

In a case where the customer service managing section 111 determines that there are no unselected clerks (S406: No), the customer service managing section 111 specifies the store ID and the clerk ID of a clerk having the highest skill in the clerks specified in Step S402, and transmits a clerk-awaited-state notification including the clerk ID to a robot installed at the store represented by the store ID (S407). The process in Step S407 corresponds to the process in Step S240.

When the customer service managing section 111 receives a clerk-awaited-state available response as a reply to the clerk-awaited-state notification from the robot, the customer service managing section 111 transmits a clerk-awaited-state notification to the terminal 2 having transmitted the customer service request received in Step S401 (S408), and ends the process performed by the customer service management server 1. The process in Step S408 corresponds to the process in Step S243.

Note that the customer service managing section 111 may not take into consideration skills in Step S403 or Step S407. Specifically, for example, in Step S403 and Step S407, the customer service managing section 111 may select a clerk randomly from the clerks specified in Step S402 (n.b., a condition that an unselected clerk has to be selected is added further in Step S403).

In addition, whereas the customer service managing section 111 performs the selection process in units of clerks in Step S403 in the example depicted in FIG. 12, the customer service managing section 111 may perform the selection process in units of stores. Specifically, for example, in Step S403, the customer service managing section 111 may specify stores where there are the clerks specified in Step S402 and the number of the specified clerks stationed at the stores, select, among the specified stores, an unselected store with the largest number of the clerks specified in Step S402, and transmit a customer service request including the clerk IDs and the skills of the clerks specified in Step S402 who are stationed at the selected store to a robot arranged at the selected store. In this case, in Step S406, the customer service managing section 111 determines whether an unselected store is included in the specified stores. In addition, in this case, the robot having received the customer service request determines whether subject clerks are occupied with customer service, in the descending order of skills represented by the customer service request in Step S503 and Step S504 described later, and proceeds to a process in Step S511 only in a case where all the subject clerks are occupied with customer service.

In addition, in Step S407, the customer service managing section 111 may transmit a clerk-awaited-state notification to a robot arranged at a store where the largest number of the clerks specified in Step S402 are stationed.

In addition, in Step S403, the customer service managing section 111 may transmit customer service requests including the clerk IDs and the skills of the clerks specified in Step S402 to all robots arranged at stores where the clerks specified in Step S402 are stationed. In this case, a robot that has transmitted a customer service available response earliest performs customer service by remote communication (at this time, if the customer service available response is transmitted also to other robots, it can be recognized that remote communication by those robots are unnecessary). In addition, in this case, the robot having received the customer service request determines whether subject clerks are occupied with customer service, in the descending order of skills represented by the customer service request in Step S503 and Step S504 described later, and proceeds to a process in Step S511 only in a case where all the subject clerks are occupied with customer service.

In addition, in Step S403, the customer service managing section 111 may transmit clerk-awaited-state notifications including the clerk IDs of clerks having the highest skills in the clerks specified in Step S402 to all robots arranged at stores where the clerks specified in Step S402 are stationed. In this case, a robot having transmitted a remote communication start request message earliest performs customer service by remote communication (at this time, if the remote communication start request message is transmitted also to other robots, it can be recognized that remote communication by those robots are unnecessary).

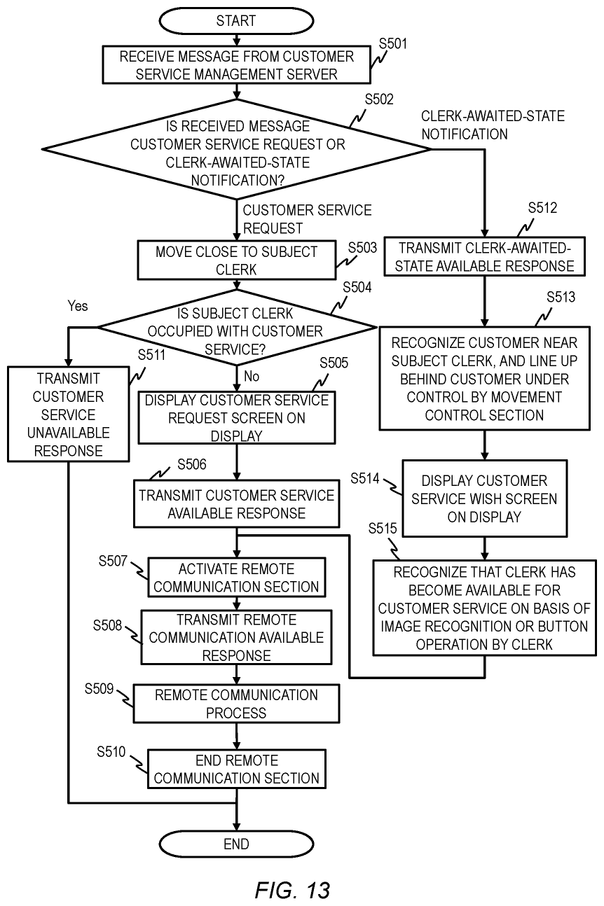

FIG. 13 is a flowchart depicting an example of a specific process performed by the robot 3a. Note that, since the robot 3b also executes a process similar to the process executed by the robot 3a, an explanation regarding details of the process performed by the robot 3b is omitted.

The customer service request processing section 311 of the robot 3a receives a message from the customer service management server 1 (S501). The customer service request processing section 311 determines whether the message received in Step S501 is a customer service request or a clerk-awaited-state notification (S502).

In a case where the customer service request processing section 311 determines that the message received in Step S501 is a customer service request (S502: customer service request), the movement control section 312 controls the moving mechanism 307 to move the robot 3a closer to a clerk (subject clerk) corresponding to a clerk ID included in the customer service request (S503).

Specifically, for example, the customer service request processing section 311 acquires, from the clerk image table 321, an image corresponding to the clerk ID represented by the customer service request, executes person recognition using images captured by a camera included in the input device 305, while the movement control section 312 is moving the robot 3a, and stops the movement performed by the movement control section 312, in a case where it is determined that a person corresponding to the acquired image is included in a captured image. In addition, for example, each clerk may have a tag, and the movement control section 312 may move the robot 3a to a tag corresponding to the clerk ID represented by the customer service request.

The customer service request processing section 311 determines whether the subject clerk is occupied with customer service (S504). Specifically, for example, the customer service request processing section 311 captures, by the camera included in the input device 305, an image including the subject clerk, determines that the subject clerk is occupied with customer service, in a case where a person other than persons represented by the images included in the clerk image table 321 is included in the image (i.e., in a case where a person (customer) who is not a clerk at the store is also captured in the image), and determines that the subject clerk is not occupied with customer service, in a case where persons other than the persons represented by the images included in the clerk image table 321 are not included in the image.

In a case where the customer service request processing section 311 determines that the subject clerk is not occupied with customer service (S504: No), the customer service request processing section 311 displays a customer service request screen on a display included in the output device 306 (S505). Note that the customer service request screen displays a message indicating that there is a customer service request from a remote location (commercial facility). Note that, for example, the customer service request transmitted from the terminal 2 via the customer service management server 1 may include a commercial facility ID, the item ID of a sample item, or the like, and, in this case, the customer service request screen may also display the commercial facility ID, the item ID, or the like. The processes in Step S503 to Step S505 correspond to the process in Step S205.

The customer service request processing section 311 transmits a customer service available response to the customer service management server 1 (S506). The process in Step S506 corresponds to the process in Step S206. The robot 3a activates the remote communication section 313 (S507), and the remote communication section 313 transmits a remote communication available response to the terminal 2 having transmitted the customer service request (S508). The process in Step S507 corresponds to the process in Step S208 and part of the process in Step S244, and the process in Step S508 corresponds to the process in Step S209.

The remote communication section 313 executes a remote communication process (S509). Specifically, for example, the remote communication section 313 controls a camera and a microphone included in the input device 305, a speaker included in the output device 306, and the like, to realize a video telephone functionality or the like between a clerk who uses the robot 3a and a customer who uses the terminal 2 and thereby realize remote communication.

Upon the end of customer service, the remote communication section 313 is ended (S510), and the process performed by the robot 3a ends. For example, the end of customer service is triggered by the customer at the commercial facility inputting a customer service end instruction by using the input device 205 of the terminal 2, the clerk at the store where the robot is arranged inputting a customer service end instruction by using the input device 305 of the robot 3a, or the like. The process in Step S510 corresponds to the process in Step S213.

In a case where the customer service request processing section 311 determines that the subject clerk is occupied with customer service (S504: Yes), the customer service request processing section 311 transmits a customer service unavailable response to the customer service management server 1 (S511), and ends the process performed by the robot 3a. The process in Step S511 corresponds to the process in Step S236.

In a case where the customer service request processing section 311 determines that the message received in Step S501 is a clerk-awaited-state notification (S502: clerk-awaited-state notification), the customer service request processing section 311 transmits a clerk-awaited-state available response to the customer service management server 1 (S512). The process in Step S512 corresponds to the process in Step S240.

The movement control section 312 controls the moving mechanism 307 to move the robot 3a such that the robot 3a lines up behind a customer near the clerk (subject clerk) corresponding to the clerk ID included in the clerk-awaited-state notification (S513). Specifically, for example, the robot 3a moves closer to the subject clerk by a method similar to that in Step S503, then the customer service request processing section 311 captures, by the camera included in the input device 305, an image including the subject clerk, and recognizes, as a customer, a person other than the persons represented by the images included in the clerk image table 321, and the movement control section 312 controls the moving mechanism 307 such that the robot 3a moves to the back of the customer.

The customer service request processing section 311 displays a customer service wish screen on the display included in the output device 306 (S514). Details of the customer service wish screen are described later by using FIG. 15.

The customer service request processing section 311 recognizes that the subject clerk has become available for customer service (S515). Specifically, for example, the customer service request processing section 311 may recognize that the subject clerk has become available for customer service according to operation of a button included in the input device 305, or may recognize that the subject clerk has become available for customer service, in a case where it is determined that an image captured by the camera included in the input device 305 no longer includes a customer. The process in Step S515 corresponds to part of the process in Step S244. Subsequent to the process in Step S515, the procedure proceeds to the process in Step S507.

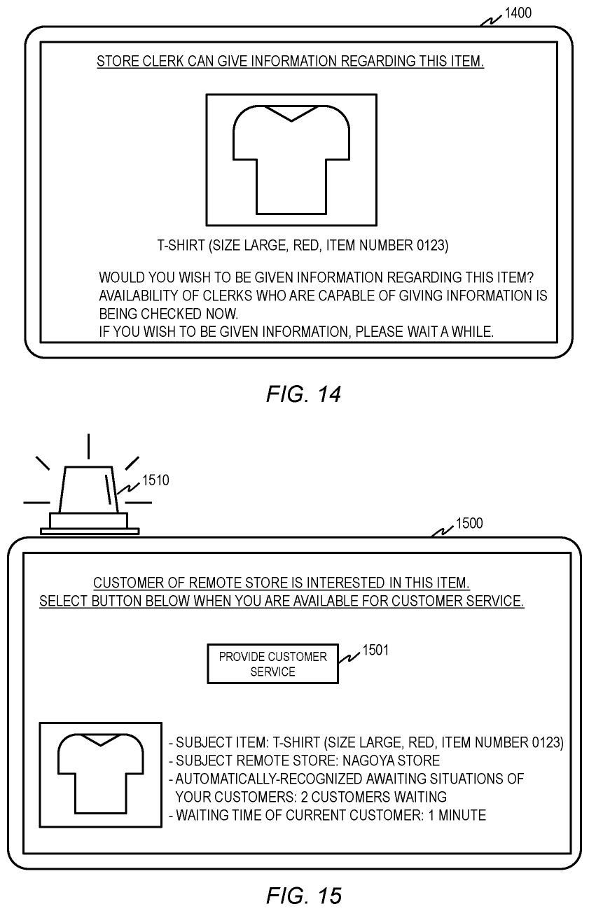

FIG. 14 is a figure depicting a screen configuration example of a clerk-awaited-state screen. For example, a clerk-awaited-state screen 1400 displays a message indicating that clerks at stores are capable of giving an explanation regarding a sample item that a customer of the commercial facility holds in her/his hand, a message indicating that the availability of the clerks at the stores is being checked, the item ID of the sample item, and the like. In addition, an image of each sample item may be stored in the sample item management table 222, and, in this case, the clerk-awaited-state screen 1400 may display the image of the sample item that the customer of the commercial facility holds in her/his hand.

By this manner of display on the clerk-awaited-state screen 1400, the customer can recognize that she/he can be provided with customer service by a clerk, and it is possible to avoid loss of sales opportunities that can be caused when the customer leaves the place before the remote customer service is started.

FIG. 15 is a figure depicting a screen configuration example of a customer service wish screen. For example, a customer service wish screen 1500 displays a message indicating that there is a customer service wish from a remote location (commercial facility), a button 1501 to be selected when a subject clerk has become available for customer service (if the button 1501 is selected, a remote communication available response is transmitted), and the like.

In addition, an image of each sample item may be stored in the sample item management table 222, a customer service request transmitted from the terminal 2 may include a commercial facility ID, the item ID and the sample image of a sample item, and the like, and further, a clerk-awaited-state notification transmitted from the customer service management server 1 may include the commercial facility ID and the item ID and the sample image of the sample item. In this case, the customer service wish screen 1500 may display the commercial facility ID, the item ID and the sample image of the sample item, and the like.

In addition, the customer service request processing section 311 may recognize the number of customers included in an image including the subject clerk, and, in this case, the customer service wish screen 1500 may display the number of the recognized customers. In addition, the customer service wish screen 1500 may display time (e.g., measured by the customer service request processing section 311) elapsed from reception of a customer service request (or from reception of a clerk-awaited-state notification) as waiting time of a customer of a remote location (commercial facility).

In addition, the robot 3a may include a lamp 1510, and, in order to make it easier for a subject clerk to recognize that there is a customer service wish from the commercial facility, the lamp 1510 may be turned on when the customer service wish screen 1500 is being displayed.

In addition, in order for a subject clerk to recognize that there is a customer service wish from the commercial facility, a speaker included in the output device 306 of the robot 3a may output a beep, a message displayed on the customer service wish screen 1500, or the like.

As explained thus far, in the remote customer service system according to the present embodiment, sample items and sensors are arranged at the commercial facility which is a remote location, and when it is sensed by a sensor that a customer of the commercial facility holds a sample item in her/his hand, for example, a customer service request is transmitted to a robot arranged at a store where there is a clerk. As a result, the customer of the commercial facility does not have do work of selecting the item that she/he is interested in on a screen, for example, and, in addition, remote customer service can be provided from a store accurately to the customer who is interested in the item.

In addition, in the remote customer service system according to the present embodiment, customer service requests are transmitted to robots of a plurality of stores where there are clerks who are capable of giving an explanation regarding a sample item that a customer of the commercial facility holds in her/his hand, and time during which the customer waits for remote customer service can thereby be shortened.

In addition, in the remote customer service system according to the present embodiment, in a case where a clerk who is capable of giving an explanation regarding a sample item that a customer of the commercial facility holds in her/his hand is occupied with customer service for another customer, for example, a waiting notification is transmitted to a robot, and remote customer service can thereby be performed promptly after the clerk has become available.

In this manner, the remote customer service system according to the present embodiment can realize remote customer service that reduces work to be done by a store-operating company for operating a commercial facility, reduce work to be done by a customer of the commercial facility, and shorten waiting time of a customer of the commercial facility.

Note that, whereas the customer service management server 1 controls remote customer service in the example explained in the present embodiment, the customer service management system may not include the customer service management server 1. Specifically, for example, the terminal 2 may double as the customer service management server 1 to execute the functionalities of the customer service management server 1, and, in this case, communication between the customer service management server 1 and the terminal 2 in the present embodiment is omitted.

In addition, for example, the customer service management system may not include the customer service management server 1, and the robot 3a and the robot 3b may double as the customer service management server 1 to execute the functionalities of the customer service management server 1. In this case, communication between the customer service management server 1 and the robot 3a and robot 3b in the present embodiment is omitted. In addition, in this case, it is sufficient if, by causing the robots to transmit customer service available responses, customer service unavailable responses, and remote communication responses to each other, for example, a robot having transmitted a customer service available response earliest executes remote communication. In a case where customer service unavailable responses are transmitted from all the robots, it is sufficient if all the robots execute a clerk-awaited-state process and a robot having transmitted a remote communication response earliest executes remote communication.

Note that the present invention is not limited to the embodiment described above, and includes various modifications. For example, the embodiment described above is explained in detail in order to explain the present invention in an easy-to-understand manner, and the present invention is not necessarily limited to an embodiment including all the constituent elements explained. In addition, some of the constituent elements of an embodiment can also be replaced with constituent elements of another embodiment, and constituent elements of an embodiment can also be added to the constituent elements of another embodiment. In addition, some of the constituent elements of each embodiment can additionally have other constituent elements, be deleted, or be replaced with other constituent elements.

In addition, some or all of the constituent elements, functionalities, processing sections, processing means, and the like described above may be realized by hardware by, for example, designing them in an integrated circuit (IC) and by other methods. In addition, the constituent elements, functionalities, and the like described above may be realized by software by a processor interpreting and executing a program to realize respective functionalities. Information such as a program, a table, or a file to realize each functionality can be placed on a recording device such as a memory, a hard disk, or an SSD or a recording medium such as an IC card, a secure digital (SD) card, or a digital versatile disc (DVD).

In addition, depicted control lines and information lines are ones that are considered to be necessary for explanation, and all control lines and information lines that are necessary for products are not necessarily depicted. It may be considered that actually almost all constituent elements are interconnected.

What is claimed is:

1. A remote customer service system that retains
condition information representing a condition related to a sensing value of a sensor that senses an action of a customer regarding an item arranged at a facility, and
clerk information representing a store where a clerk who is capable of providing customer service regarding the item is stationed,
the remote customer service system comprising:
a sensor processing section that acquires a sensing value of the sensor, and generates a customer service request in a case where it is determined that the acquired sensing value satisfies the condition;
a customer service managing section that transmits the customer service request to a computer arranged at a store represented by the clerk information; and
a remote communication section that executes remote communication between a computer having received the customer service request and a computer arranged at the facility.

2. The remote customer service system according to claim 1, wherein
the clerk information represents a customer service skill of a clerk regarding the item, and
the customer service managing section transmits the customer service request to a computer arranged at a store where a clerk having a highest skill is stationed, among stores represented by the clerk information.

3. The remote customer service system according to claim 1, wherein
the clerk information represents a clerk who is capable of providing customer service regarding the item at the store, and
the customer service managing section transmits the customer service request to a computer arranged at a store with a largest number of clerks who are capable of providing customer service regarding the item, among stores represented by the clerk information.

4. The remote customer service system according to claim 1, wherein
the clerk information represents a clerk who is capable of providing customer service regarding the item at the store, and
the customer service managing section includes, in the customer service request transmitted to a computer arranged at a store represented by the clerk information, information representing a clerk who is represented by the clerk information, is capable of providing customer service regarding the item, and is stationed at the store,
the remote customer service system further includes a customer service request processing section that determines whether the clerk represented by the customer service request is occupied with customer service, and
the remote communication section executes remote communication between the computer arranged at the store where the clerk is stationed and the computer arranged at the facility, in a case where the customer service request processing section determines that the clerk represented by the customer service request is not occupied with customer service.

5. The remote customer service system according to claim 4, wherein
the customer service managing section transmits, to a computer having transmitted the customer service request, a clerk-awaited-state notification representing a clerk who is represented by the clerk information and is stationed at the store where the computer is arranged, in a case where the customer service request processing section determines that clerks represented by the customer service request at all stores where computers having received the customer service request are arranged are occupied with customer service, and
the customer service request processing section displays a customer service wish screen representing that there is a customer service request from a customer at the facility, on a display device included in a computer having received the clerk-awaited-state notification.

6. The remote customer service system according to claim 5, wherein
the remote communication section executes remote communication between the computer having received the clerk-awaited-state notification and the computer arranged at the facility, in a case where the customer service request processing section determines that a clerk who is stationed at a store where the computer having received the clerk-awaited-state notification is arranged and who is represented by the clerk-awaited-state notification has become available for customer service.

7. The remote customer service system according to claim 5, wherein
the clerk information represents a customer service skill of a clerk regarding the item, and
the customer service managing section transmits the clerk-awaited-state notification to a computer arranged at a store where, according to the clerk information, a clerk having a highest skill is stationed, in a case where the customer service request processing section determines that clerks represented by the customer service request at all stores where computers having received the customer service request are arranged are occupied with customer service.

8. The remote customer service system according to claim 5, wherein
the customer service request processing section measures time elapsed since the computer having received the clerk-awaited-state notification has received the clerk-awaited-state notification, and
displays the measured elapsed time on the customer service wish screen.

9. The remote customer service system according to claim 1, wherein
the condition includes that the customer has reached for the item at least a predetermined number of times.

10. The remote customer service system according to claim 1, wherein
the sensor processing section displays, on a display device included in the computer arranged at the facility, a clerk-awaited-state screen representing that a clerk at a store is capable of providing customer service regarding the item and that availability of the clerk at the store is being checked, in a case where the customer service request is generated.

11. A remote customer service method by a remote customer service system that retains
condition information representing a condition related to a sensing value of a sensor that senses an action of a customer regarding an item arranged at a facility, and
clerk information representing a store where a clerk who is capable of providing customer service regarding the item is stationed,
the remote customer service method comprising:
a sensor process of acquiring a sensing value of the sensor, and generating a customer service request in a case where it is determined that the acquired sensing value satisfies the condition;
a customer service managing process of transmitting the customer service request to a computer arranged at a store represented by the clerk information; and
a remote communication process of executing remote communication between a computer having received the customer service request and a computer arranged at the facility.
